(19) United States
(12) Patent Application Publication
(10) Pub. No.: US 2021/0390454 A1
(43) Pub. Date: Dec. 16, 2021

(54) METHOD AND APPARATUS FOR TRAINING MACHINE READING COMPREHENSION MODEL AND NON-TRANSITORY COMPUTER-READABLE MEDIUM

(71) Applicants: Tianxiong XIAO, Beijing (CN); Yixuan TONG, Beijing (CN); Bin DONG, Beijing (CN); Shanshan JIANG, Beijing (CN); Jiashi ZHANG, Beijing (CN)

(72) Inventors: Tianxiong XIAO, Beijing (CN); Yixuan TONG, Beijing (CN); Bin DONG, Beijing (CN); Shanshan JIANG, Beijing (CN); Jiashi ZHANG, Beijing (CN)

(73) Assignee: Ricoh Company, Ltd., Tokyo (JP)

(21) Appl. No.: 17/343,955

(22) Filed: Jun. 10, 2021

(30) Foreign Application Priority Data
Jun. 12, 2020 (CN) 202010535636.1

(51) Int. Cl. G06N 20/00; G06F 40/20; G06K 9/62

(52) U.S. Cl. CPC G06N 20/00; G06K 9/6215; G06F 40/20

(57) ABSTRACT

Disclosed is an apparatus for training a machine reading comprehension model. The apparatus is inclusive of a distance calculation part configured to calculate, based on a position of each word within a training text and a position of an answer label within the training text, a distance between the same word and the answer label; a label smoothing part configured to input the distance between the same word and the answer label into a smooth function to obtain a probability value corresponding to the same word, outputted from the smooth function; and a model training part configured to make the probability value corresponding to the same word serve as a smoothed label of the same word so as to train the machine reading comprehension model.

### BACKGROUND OF THE DISCLOSURE

### 1. Field of the Disclosure

The present disclosure relates to the technical field of machine learning and natural language processing (NLP), and more particularly relates to a method and apparatus for training a machine reading comprehension (MRC) model as well as a non-transitory computer-readable medium.

### 2. Description of the Related Art

Machine reading comprehension refers to the automatic and unsupervised understanding of text. Making a computer have the ability to acquire knowledge and answer a question by means of text data is considered to be a key step of building a general intelligent agent. The task of machine reading comprehension is to let a machine learn how to answer a question raised by a human being on the basis of the contents of an article. This type of task may be used as a basic approach to test whether a computer can well understand natural language. In addition, machine reading comprehension has a wide range of applications, for example, search engines, e-commerce, and education.

In the past two decades or so, natural language processing provided many powerful approaches for low-level syntactic and semantic text processing tasks, such as parsing, semantic role labelling, text classification, and the like. During the same period, important breakthroughs were also made in the field of machine learning and probabilistic reasoning. Recently, the research about artificial intelligence (AI) has gradually turned its focus on how to utilize these advances to understand text.

Here, understanding text means forming a set of coherent understanding based on the related text corpus and background/theory. Generally speaking, after reading an article, people may make a certain impression in their minds, such as who the article is about, what they did, what happened, where it happened, and so on. In this way, people can easily outline the major points of the article. The study on machine reading comprehension is to give a computer the same reading ability as human beings, namely, make the computer read an article, and have the computer answer a question relating to the information within the article.

The problems faced by machine reading comprehension are actually similar to the problems faced by human reading comprehension. However, in order to reduce the difficulty of a task, many current researches on machine reading comprehension exclude world knowledge, and adopt only relatively simple data sets constructed manually to answer some relatively simple questions. The common task forms to give an article and a corresponding question needing to be understood by a machine include an artificially synthesized question and answer form, a cloze style query form, a multiple choice question form, etc.

For example, the artificially synthesized question and answer form is giving a manually constructed article composed of a number of simple facts as well as corresponding questions, and requiring a machine to read and understand the contents of the article and use reasoning to arrive at the correct answers of the corresponding questions. The correct answers are often the key words or entities within the article.

At present, large-scale pre-trained language models are mostly adopted when carrying out machine reading comprehension. By searching for the correspondence between each word within an article and each word within a question raised by a human being (this kind of correspondence may also be called alignment information), deep features can be discovered. Then, on the basis of the deep features, it is possible to find the original sentence within the article to answer the question.

FIG. 1 illustrates a pre-trained language model in the prior art.

As shown in FIG. 1, by letting an article and question retrieved be input text, the pre-trained language model is able to encode the article and question; calculate the alignment information between the words within the article and question; output probabilities of positions within the article, where the answer to the question may be located; and finally select the sentence at the position having the highest probability as the answer to the question.

However, the answers eventually given by the current machine reading comprehension technology do not have high accuracy.

### SUMMARY OF THE DISCLOSURE

In light of the above, the present disclosure provides a machine reading comprehension model training method and apparatus by which a machine reading comprehension model with high performance can be trained using less training time. As such, it is possible to increase the accuracy of answers predicted by the trained machine reading comprehension model.

According to a first aspect of the present disclosure, a method of training a machine reading comprehension model is provided that may include steps of calculating, based on the position of each word within a training text and the position of an answer label within the training text, the distance between the same word and the answer label; inputting the distance between the same word and the answer label into a smooth function to obtain a probability value corresponding to the same word, outputted from the smooth function; and making the probability value corresponding to the same word serve as a smoothed label of the same word so as to train the machine reading comprehension model.

Here, in a case where the absolute value of the distance between the same word and the answer label is greater than zero and less than a predetermined threshold, if the same word is a stop word, then the probability value outputted by the smooth function is a first value greater than zero and less than one, and if the same word is not a stop word, then the probability value outputted by the smooth function is zero. In a case where the absolute value of the distance between the same word and the answer label is greater than or equal to the predetermined threshold, the probability value outputted from the smooth function is zero. Additionally, in a case where the distance between the same word and the answer label is equal to zero, the smooth function outputs a maximum value, and the maximum value is greater than 0.9 and less than 1.

Moreover, in accordance with at least one embodiment, the first value is negatively correlated with the absolute value of the distance between the same word and the answer label.

Furthermore, in accordance with at least one embodiment, the answer label is inclusive of an answer starting label and an answer ending label. The distance between the same word and the answer label includes a starting distance between the same word and the answer starting label and an ending distance between the same word and the answer ending label. In a case where the answer label is an answer starting label, the probability value corresponding to the same word indicates the probability of the same word being the answer starting label. In a case where the answer label is an answer ending label, the probability value corresponding to the same word is indicative of the probability of the same word being the answer ending label.

Additionally, in accordance with at least one embodiment, the step of making the probability value corresponding to the same word serve as a smoothed label of the same word so as to train the machine reading comprehension model includes using the probability value of the same word to replace the label corresponding to the same word so as to train the machine reading comprehension model.

Moreover, in accordance with at least one embodiment, the method of training a machine reading comprehension model is further inclusive of utilizing the trained machine reading comprehension model to carry out answer label prediction with respect to an article and question inputted.

According to a second aspect of the present disclosure, an apparatus for training a machine reading comprehension model is provided that may contain a distance calculation part configured to calculate, based on the position of each word within a training text and the position of an answer label within the training text, a distance between the same word and the answer label; a label smoothing part configured to input the distance between the same word and the answer label into a smooth function to obtain a probability value corresponding to the same word, outputted from the smooth function; and a model training part configured to make the probability value corresponding to the same word serve as a smoothed label of the same word so as to train the machine reading comprehension model.

Here, in a case where the absolute value of the distance between the same word and the answer label is greater than zero and less than a predetermined threshold, if the same word is a stop word, then the probability value outputted by the smooth function is a first value greater than zero and less than one, and if the same word is not a stop word, then the probability value outputted from the smooth function is zero. In a case where the absolute value of the distance between the same word and the answer label is greater than or equal to the predetermined threshold, the probability value outputted by the smooth function is zero. In addition, in a case where the distance between the same word and the answer label is equal to zero, the smooth function outputs a maximum value, and the maximum value is greater than 0.9 and less than 1.

Moreover, in accordance with at least one embodiment, the first value is negatively correlated with the absolute value of the distance between the same word and the answer label.

Furthermore, in accordance with at least one embodiment, the answer label is inclusive of an answer starting label and an answer ending label. The distance between the same word and the answer label includes a starting distance between the same word and the answer starting label and an ending distance between the same word and the answer ending label. In a case where the answer label is an answer starting label, the probability value corresponding to the same word indicates the probability of the same word being the answer starting label. In a case where the answer label is an answer ending label, the probability value corresponding to the same word is indicative of the probability of the same word being the answer ending label.

Furthermore, in accordance with at least one embodiment, the apparatus for training a machine reading comprehension model is further inclusive of an answer labelling part configured to utilize the trained machine reading comprehension model to carry out answer label prediction with respect to an article and question inputted.

According to a third aspect of the present disclosure, an apparatus for training a machine reading comprehension model is provided that may be inclusive of a processor and a memory (i.e., a storage) connected to the processor. The memory stores a processor-executable program (i.e., a computer-executable program) that, when executed by the processor, may cause the processor to conduct the method of training a machine reading comprehension model.

According to a fourth aspect of the present disclosure, a computer-executable program and a non-transitory computer-readable medium are provided. The computer-executable program may cause a computer to perform the method of training a machine reading comprehension model. The non-transitory computer-readable medium stores computer-executable instructions (i.e., the processor-executable program) for execution by a computer involving a processor. The computer-executable instructions, when executed by the processor, may render the processor to carry out the method of training a machine reading comprehension model.

Compared to the existing machine reading comprehension technology, the method and apparatus for training a machine reading comprehension model according to the embodiments of the present disclosure may merge the probability information of a stop word(s) near the answer boundary into the model training process, so a high-performing machine reading comprehension model can be trained with less training time. In this way, it is possible to improve the accuracy of answer prediction performed by the trained machine reading comprehension model.

### BRIEF DESCRIPTION OF THE DRAWINGS

FIG. 1 illustrates a pre-trained language model in the prior art

FIG. 2 is a flowchart of a method of training a machine reading comprehension model according to a first embodiment of the present disclosure;

FIG. 3 illustrates a table including the distance between each word and an answer label within a given training text, calculated in the first embodiment of the present disclosure;

FIG. 4 shows an exemplary smooth function adopted in the first embodiment of the present disclosure;

FIG. 5 illustrates a table containing the probability values generated in the first embodiment of the present disclosure;

FIG. 6 presents an exemplary structure of the machine reading comprehension model provided in the first embodiment of the present disclosure;

FIG. 7 is a block diagram of an apparatus for training a machine reading comprehension model according to a second embodiment of the present disclosure; and

FIG. 8 is a block diagram of another apparatus for training a machine reading comprehension model according to a third embodiment of the present disclosure.

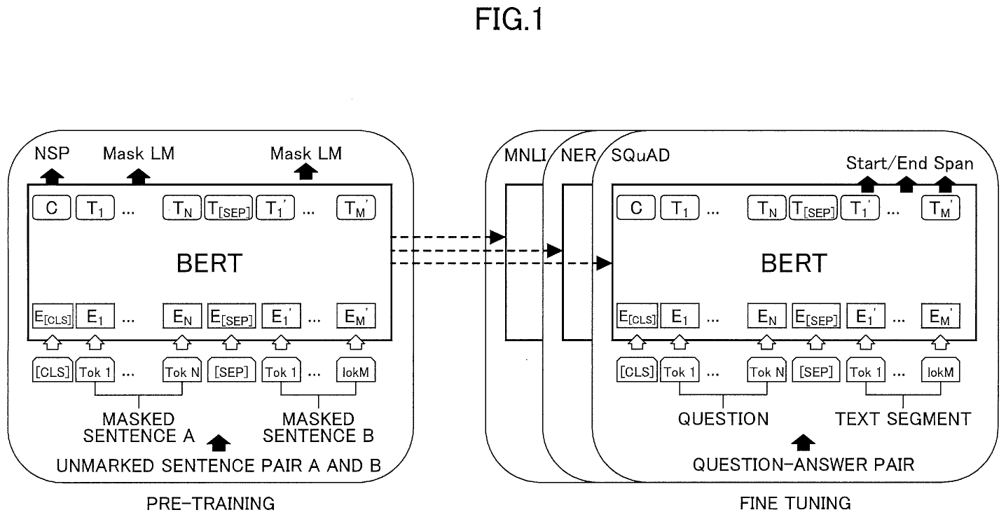

### DETAILED DESCRIPTION OF THE PREFERRED EMBODIMENTS

In order to let a person skilled in the art better understand the present disclosure, hereinafter, the embodiments of the present disclosure are concretely described with reference to the drawings. However, it should be noted that the same symbols, that are in the specification and the drawings, stand for constructional elements having basically the same function and structure, and the repetition of the explanations to the constructional elements is omitted.

### First Embodiment

In this embodiment, a method (also called a training method) of training a machine reading comprehension model is provided that is especially suitable for seeking the answer to a predetermined question, from a given article. The answer to the predetermined question is usually a part of text within the given article.

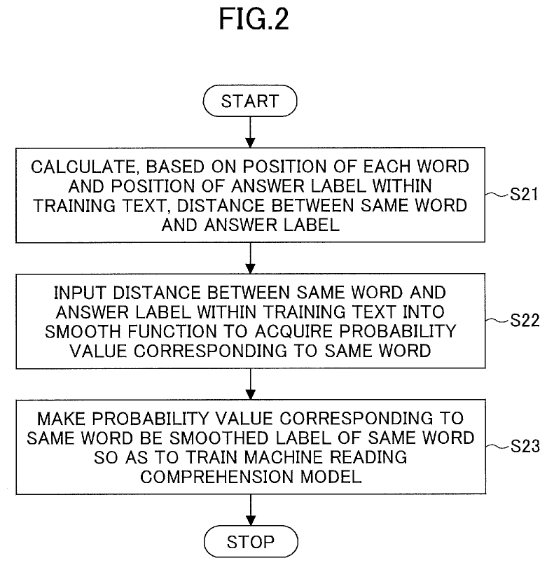

FIG. 2 is a flowchart of the training method according to this embodiment. As shown in FIG. 2, the training method includes STEPS S21 to S23.

STEP S21 is calculating, based on the position of each word and the position of an answer label within a training text, the distance between the same word and the answer label.

Here, the training text may be a given article. The answer label is for marking the specific position of the answer to a predetermined question, within the given article. A well-used marking approach is one-hot encoding. For example, the positions of the starting word and the ending word of the answer within the given article may be respectively marked as 1 (i.e., an answer starting label and an answer ending label), and all the positions of the other words within the given article may be marked as 0.

When calculating the distance between each word and an answer label within a training text, it is possible to acquire the difference between the absolute position of the same word and the absolute position of the answer label. Here, the absolute position of a word within the training text refers to the order of the word thereof, and the answer label may include an answer starting label and an answer ending label that are respectively used to indicate the starting position and the ending position of the answer to a predetermined question, within the training text. As such, the distance between each word and the answer label within the training text may be inclusive of a starting distance between the same word and the answer starting label and an ending distance between the same word and the answer ending label.

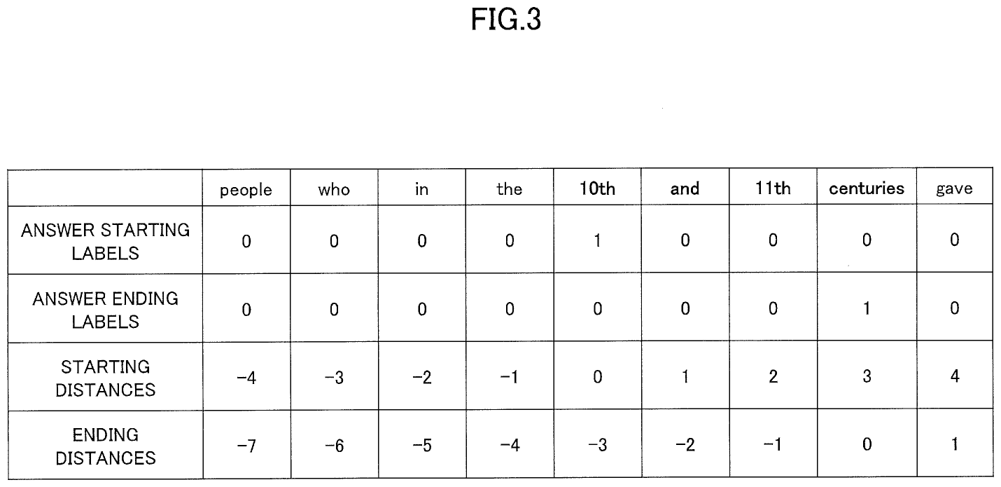

FIG. 3 illustrates a table (hereinafter, called a first table) including the distance between each word and an answer label within a given training text, calculated in this embodiment.

It is assumed that the given training text is “people who in the 10th and 11th centuries gave”; the absolute positions of the respective words within the given training text are 1 (“people”), 2 (“who”), 3 (“in”), 4 (“the”), 5 (“10^{th}”), 6 (“and”), 7 (“11^{th}”), 8 (“centuries”), and 9 (“gave”) in order; and the answer to a predetermined question is “10^{th} and 11^{th} centuries”, namely, the position of the answer starting label is 5 (“10^{th}”), and the position of the answer ending label is 8 (“centuries”). As presented in the first table, when one-hot encoding is adopted, the position of the answer starting label (i.e., “10th”) is marked as 1 (i.e., the answer starting label), and all the other positions in the same row are marked as 0; and the position of the answer ending label (i.e., “centuries”) is marked as 1 (i.e., the answer ending label), and all the other positions in the same raw are marked as 0.

Consequently, for the word “people” within the given training text, the distance between this word and the answer starting label (i.e., the starting distance in the first table) is 1−5=−4, and the distance between the same word and the answer ending label (i.e., the ending distance in the first table) is 1−8=−7. For the word “who” within the given training text, the distance between this word and the answer starting label (i.e., the starting distance in the first table) is 2−5=−3, and the distance between the same word and the answer ending label (i.e., the ending distance in the first table) is 2−8=−6. In like manner, for all the other words within the given training text, it is also possible to calculate the distances between these words and the answer label (including the answer starting label and the answer ending label), as shown in the first table.

Referring again to FIG. 2; in STEP S22, the distance between the same word and the answer label within the training text is inputted into a smooth function so as to acquire a probability value corresponding to the same word, outputted from the smooth function. In a case where the absolute value of the distance between the same word and the answer label is greater than zero and less than a predetermined threshold, if the same word is a stop word, then the probability value outputted by the smooth function is a first value greater than zero and less than one, and if the same word is not a stop word, then the probability value outputted from the smooth function is zero.

Here, it should be pointed out that regarding the smooth function provided in the embodiments of the present disclosure, its input is the distance between each word and the answer label within the training text, and its output is a probability value corresponding to the same word, i.e., the probability of the same word being the answer label. In a case where the answer label is an answer starting label, the probability value corresponding to the same word refers to the probability of the same word being the answer starting label, and in a case where the answer label is an answer ending label, the probability value corresponding to the same word is indicative of the probability of the same word being the answer ending label.

It can be been seen from the above that the probability value outputted from the smooth function is a kind of distance function. Because the positional information of each word within the training text is retained in the corresponding distance, it is possible to provide latent answer boundary information. Considering that a stop word near the answer to a predetermined question may be a latent answer boundary, for example, the answer in the first table shown in FIG. 3 is “10^{th} and 11^{th} centuries”, the sentence “in the 10^{th} and 11^{th} centuries” containing stop words “in” and “the” can also be regarded as another form of the answer. Accordingly, the smooth function provided in the embodiments of the present disclosure may output a first value not equal to zero when the input of the smooth function is the distance between a stop word (e.g., “in” and “the” in this example) and the answer label. By introducing stop words as answer boundary information into model training, it is possible to speed up the model training process and improve the accuracy of answer prediction of the trained model. Whether a word within the training text is a stop word may be determined on the basis of whether this word is located in a pre-built stop word list. Stop words are usually excluded when carrying out a search process in the web search field so as to increase the search speed of web pages.

Generally speaking, the greater the distance between a word and the answer label within the training text is, the less the probability of the word being the answer boundary is. Taking account of this, in a case where the absolute value of the distance between a word and the answer label within the training text is greater than zero and less than a predetermined threshold, if this word is a stop word, then the smooth function can output the first value. Here, the first value is negatively correlated with the absolute value of the distance. Usually, the first value is a value approaching zero; for instance, the value may be within a range of 0 to 0.5.

Furthermore, when the distance between a word and the answer label within the training text is too large, the probability of this word being the answer boundary is usually very low. Consequently, a threshold may be determined in advance. If the absolute value of the distance is greater than or equal to the threshold, then the probability value outputted from the smooth function is zero. If the distance is equal to zero, then it means that this word is the position where the answer label is located. At this time, the smooth function can output a maximum value which is greater than 0.9 and less than 1.

In what follows, an example of the smooth function is provided. If a word in the given training text is a stop word, then it is possible to adopt the following smooth function F(x) to calculate the probability value corresponding to the word. Here, x stands for the distance between the word and the answer label.

$$F ( x ) = \frac{1}{\sqrt{2 π} σ} exp ( - \frac{( 1.5 {x}^{2} )}{2 {σ}^{2}} ) + 0.9 δ ( x ) \qquad$$

In the above equation, σ=6; if x=0, then δ(x)=1; and if x≠0, then δ(x)=1.

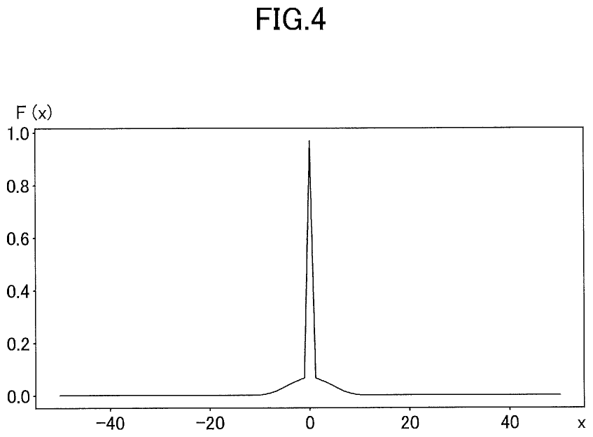

FIG. 4 illustrates the smooth function F(x). It can be seen from this drawing that if x=0, then F(x) may output a maximum value, and F(x) is negatively correlated with |x|, namely, the smaller |x| is, the greater F(x) is.

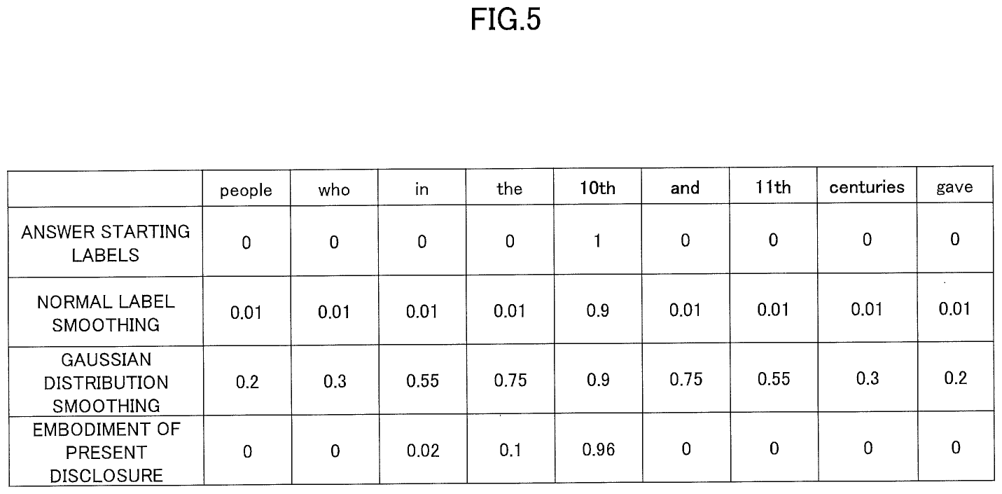

FIG. 5 shows a table (hereinafter, also called as a second table) containing the probability values generated using the answer starting labels in the first table shown in FIG. 3.

As presented in the second table, compared to the normal label smoothing and Gaussian distribution smoothing in the prior art, different approaches of calculating probability values are respectively introduced with respect to stop words and non-stop words in this embodiment, so that in the follow-on model training process, by using the probability values of the stop words, the stop words may be introduced to serve as the answer boundary information.

Again, referring to FIG. 2; STEP S23 is letting the probability value corresponding to the same word be a smoothed label of the same word so as to train a machine reading comprehension model.

Here, it is possible to use the probability value corresponding to each word within the training text to replace the label corresponding to the same word (e.g., the answer starting labels in the second row of the second table shown in FIG. 5) so as to train the machine reading comprehension model. The label corresponding to the same word is utilized to indicate the probability of the same word being the answer label. The probability value corresponding to each word obtained in STEP S22 of FIG. 2 may be adopted as the smoothed label of the same word. For instance, regarding the example shown in the first table presented in FIG. 3, the respective smoothed labels are presented in the last row of the second table shown in FIG. 5. Because both “in the 10^{th} and 11^{th} centuries” and “the 10^{th} and 11^{th} centuries” are correct answers, the label information related to the stop words may be involved into the subsequent model training process.

In general, the process of training a machine reading comprehension model is inclusive of (1) using standard distribution to randomly initialize the parameters of the machine reading comprehension model; and (2) inputting training data (including the training text, the predetermined question, and the smoothed label of each word within the training text) and adopting gradient descent to optimize a loss function so as to perform training. The loss function may be defined by the following formula.

Loss=−Σlabelᵢ log pᵢ

Here, labelᵢ indicates the smoothed label of the i-th word within the training text (i.e., the probability value corresponding to the i-th word acquired in STEP S22 of FIG. 2), and pᵢ denotes the probability value of the i-th word being the answer label outputted from the machine reading comprehension model.

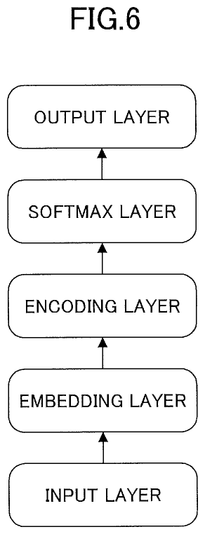

FIG. 6 illustrates a well-used machine reading comprehension model structure. As shown in this drawing, the structure contains an input layer, a vector convention layer (also called an embedding layer), an encoding layer, a Softmax layer, and an output layer.

The input layer is configured to input a character sequence containing the training text and the predetermined question. Its input form is “[CLS]+the training text+[SEP]+the predetermined question+[SEP]”. Here, [CLS] and [SEP] are two special tokens for separation.

The embedding layer is configured to map the character sequence inputted by the input layer into an embedding vector.

The encoding layer is configured to extract language features from the embedding vector. In particular, the encoding layer is usually composed of a plurality of Transformer layers.

The Softmax layer is configured to conduct label prediction and output a corresponding probability (i.e., the above-described pᵢ in the loss function) for indicating the probability value of the i-th word being the answer label within the training text.

The output layer is configured to utilize, when performing model training, the corresponding probability outputted from the Softmax layer so as to construct the loss function, and when conducting answer prediction, the corresponding probability outputted from the Softmax layer so as to generate a corresponding answer.

By taking advantage of the above steps, different probability value calculation approaches may be respectively introduced with respect to stop words and non-stop words, so that it is possible to incorporate the probability information of stop words near the answer boundary into the succeeding model training process. As a result, a high-performing machine reading comprehension model can be trained with less training time. In this way, it is possible to increase the accuracy of answer prediction executed by the trained machine reading comprehension model.

Here, it is noteworthy that after STEP S23 of FIG. 2, the trained machine reading comprehension model may also be used to carry out answer label prediction in regard to an article and question inputted.

### Second Embodiment

In this embodiment, an apparatus (also called a training apparatus) for training a machine reading comprehension model is provided that may implement the machine reading comprehension model training method in accordance with the first embodiment.

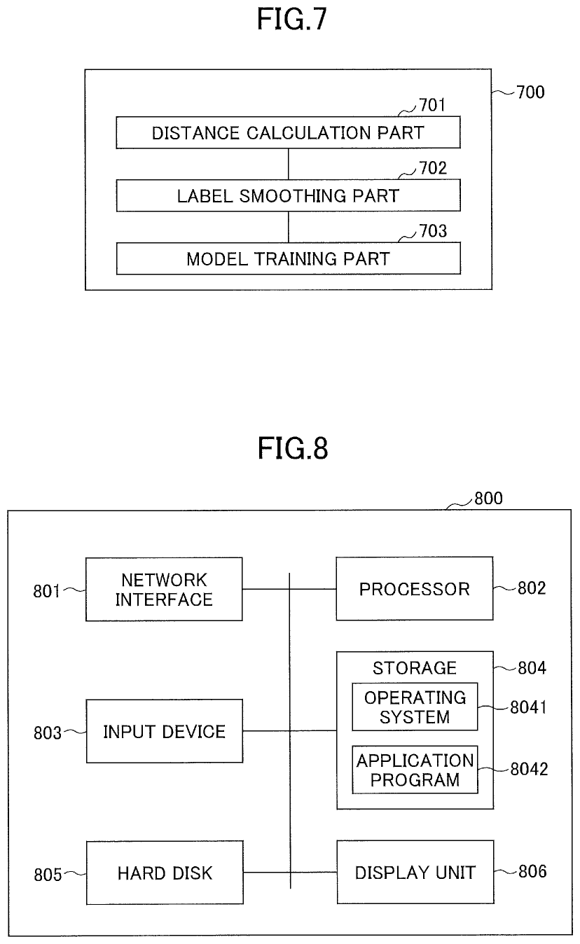

FIG. 7 is a block diagram of a training apparatus 700 for training a machine reading comprehension model according to this embodiment, by which it is possible not only to conduct answer prediction pertaining to an article and question inputted but also to reduce the training time of the machine reading comprehension model and increase the accuracy of the answer prediction.

As presented in FIG. 7, the training apparatus 700 contains a distance calculation part 701, a label smoothing part 702, and a model training part 703.

The distance calculation part 701 may be configured to calculate, on the basis of the position of each word and the position of an answer label within a training text, the distance between the same word and the answer label.

The label smoothing part 702 may be configured to input the distance between the same word and the answer label into a smooth function so as to obtain a probability value corresponding to the same word, outputted from the smooth function.

The model training part 703 may be configured to let the probability value corresponding to the same word serve as a smoothed label of the same word so as to train the machine reading comprehension model.

Here, in a case where the absolute value of the distance between the same word and the answer label is greater than zero and less than a predetermined threshold, if the same word is a stop word, then the probability value outputted by the smooth function is a first value greater than zero and less than one, and if the same word is not a stop word, then the probability value outputted from the smooth function is zero. In a case where the absolute value of the distance between the same word and the answer label is greater than or equal to the predetermined threshold, the probability value outputted by the smooth function is zero. Additionally, in a case where the distance between the same word and the answer label is equal to zero, the smooth function outputs a maximum value greater than 0.9 and less than 1.

Optionally, the first value is negatively correlated with the absolute value of the distance between the same word and the answer label.

Optionally, when the absolute value of the distance between the same word and the answer label is greater and equal to the predetermined threshold, the probability value outputted from the smooth function is zero. When the distance between the same word and the answer label is equal to zero, the smooth function outputs a maximum value, and the maximum value is greater than 0.9 and less than 1.

Optionally, the answer label is inclusive of an answer starting label and an answer ending label. The distance between the same word and the answer label includes a starting distance between the same word and the answer starting label and an ending distance between the same word and the answer ending label. In a case where the answer label is an answer starting label, the probability value corresponding to the same word indicates a probability of the same word being the answer starting label. In a case where the answer label is an answer ending label, the probability value corresponding to the same word is indicative of a probability of the same word being the answer ending label.

Optionally, the model training model 703 may be further configured to make use of the probability value corresponding to the same word to replace the label corresponding to same word, so as to train the machine reading comprehension model.

Optionally, the training apparatus 700 is further inclusive of an answer labelling part (not shown in the drawings) configured to adopt the trained machine reading comprehension model to carry out answer label prediction with respect to an article and a question inputted.

Here, it should be mentioned that the distance calculation part 701, the label smoothing part 702, and the model training part 703 in the training apparatus 700 may be configured to perform STEP S21, STEP S22, and STEP 23 of the training method according to the first embodiment, respectively. For the reason that STEPS S21 to S23 of the training method have been minutely described in the first embodiment by referring to FIG. 2, the details of them are omitted in this embodiment.

By utilizing the training apparatus 700 in accordance with this embodiment, different probability value calculation approaches may be respectively introduced with respect to stop words and non-stop words, so that it is possible to add the probability information of stop words near the answer boundary into the follow-on model training process. As a result, a high-performing machine reading comprehension model can be trained with less training time. In this way, it is possible to increase the accuracy of answer prediction executed by the trained machine reading comprehension model.

### Third Embodiment

Another machine reading comprehension model training apparatus is provided in the embodiment.

FIG. 8 is a block diagram of a training apparatus 800 for training a machine reading comprehension model according to this embodiment.

As illustrated in FIG. 8, the training apparatus 800 may contain a processor 802 and a storage 804 connected to the processor 802.

The processor 802 may be configured to execute a computer program (i.e., computer-executable instructions) stored in the storage 804 so as to fulfill the machine reading comprehension model training method in accordance with the first embodiment. The processor 802 may adopt any one of the conventional processors in the related art.

The storage 804 may store an operating system 8041, an application program 8042 (i.e., the computer program), the relating data, and the intermediate results generated when the processor 802 conducts the computer program, for example. The storage 804 may use any one of the existing storages in the related art.

In addition, as shown in FIG. 8, the training apparatus 800 may further include a network interface 801, an input device 803, a hard disk 805, and a display unit 806, which may also be achieved by using the conventional ones in the related art.

Moreover, according to another aspect, a computer-executable program and a non-transitory computer-readable medium are provided. The computer-executable program may cause a computer to perform the machine reading comprehension model training method according to the first embodiment. The non-transitory computer-readable medium may store computer-executable instructions (i.e., the computer program) for execution by a computer involving a processor. The computer-executable instructions may, when executed by the processor, render the processor to conduct the machine reading comprehension model training method in accordance with the first embodiment.

Because the steps included in the machine reading comprehension model training method have been concretely described in the first embodiment by referring to FIG. 2, the details of the steps are omitted in this embodiment for the sake of convenience.

Here it should be noted that the above embodiments are just exemplary ones, and the specific structure and operation of them may not be used for limiting the present disclosure.

Furthermore, the embodiments of the present disclosure may be implemented in any convenient form, for example, using dedicated hardware or a mixture of dedicated hardware and software. The embodiments of the present disclosure may be implemented as computer software implemented by one or more networked processing apparatuses. The network may comprise any conventional terrestrial or wireless communications network, such as the Internet. The processing apparatuses may comprise any suitably programmed apparatuses such as a general-purpose computer, a personal digital assistant, a mobile telephone (such as a WAP or 3G, 4G, or 5G-compliant phone) and so on. Since the embodiments of the present disclosure may be implemented as software, each and every aspect of the present disclosure thus encompasses computer software implementable on a programmable device.

The computer software may be provided to the programmable device using any storage medium for storing processor-readable code such as a floppy disk, a hard disk, a CD ROM, a magnetic tape device or a solid state memory device.

The hardware platform includes any desired hardware resources including, for example, a central processing unit (CPU), a random access memory (RAM), and a hard disk drive (HDD). The CPU may include processors of any desired type and number. The RAM may include any desired volatile or nonvolatile memory. The HDD may include any desired nonvolatile memory capable of storing a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

While the present disclosure is described with reference to the specific embodiments chosen for purpose of illustration, it should be apparent that the present disclosure is not limited to these embodiments, but numerous modifications could be made thereto by a person skilled in the art without departing from the basic concept and technical scope of the present disclosure.

The present application is based on and claims the benefit of priority of Chinese Patent Application No. 202010535636.1 filed on Jun. 12, 2020, the entire contents of which are hereby incorporated by reference.

What is claimed is:

1. A method of training a machine reading comprehension model, comprising:
calculating, based on a position of each word within a training text and a position of an answer label within the training text, a distance between the same word and the answer label;
inputting the distance between the same word and the answer label into a smooth function to obtain a probability value corresponding to the same word, outputted from the smooth function; and
making the probability value corresponding to the same word serve as a smoothed label of the same word so as to train the machine reading comprehension model,
wherein,
in a case where an absolute value of the distance between the same word and the answer label is greater than zero and less than a predetermined threshold, when the same word is a stop word, the probability value outputted from the smooth function is a first value greater than zero and less than one, and when the same word is not a stop word, the probability value outputted from the smooth function is zero;
in a case where the absolute value of the distance between the same word and the answer label is greater than or equal to the predetermined threshold, the probability value outputted from the smooth function is zero; and
in a case where the distance between the same word and the answer label is equal to zero, the smooth function outputs a maximum value greater than 0.9 and less than 1.

2. The method in accordance with claim 1, wherein, the first value is negatively correlated with the absolute value of the distance between the same word and the answer label.

3. The method in accordance with claim 1, wherein,
the answer label is inclusive of an answer starting label and an answer ending label;
the distance between the same word and the answer label includes a starting distance between the same word and the answer starting label and an ending distance between the same word and the answer ending label;
in a case where the answer label is the answer starting label, the probability value corresponding to the same word indicates a probability of the same word being the answer starting label; and
in a case where the answer label is the answer ending label, the probability value corresponding to the same word is indicative of a probability of the same word being the answer ending label.

4. The method in accordance with claim 1, wherein,
the making the probability value corresponding to the same word serve as a smoothed label of the same word so as to train the machine reading comprehension model includes
using the probability value corresponding to the same word to replace a label corresponding to the same word so as to train the machine reading comprehension model.

5. The method in accordance with claim 1, wherein, the answer label includes an answer starting label and an answer ending label.

6. The method in accordance with claim 1, further comprising:
adopting the trained machine reading comprehension model to carry out answer label prediction with respect to an article and question inputted.

7. An apparatus for training a machine reading comprehension model, comprising:
a distance calculation part configured to calculate, based on a position of each word within a training text and a position of an answer label within the training text, a distance between the same word and the answer label;
a label smoothing part configured to input the distance between the same word and the answer label into a smooth function to obtain a probability value corresponding to the same word, outputted from the smooth function; and
a model training part configured to make the probability value corresponding to the same word serve as a smoothed label of the same word so as to train the machine reading comprehension model,
wherein,
in a case where an absolute value of the distance between the same word and the answer label is greater than zero and less than a predetermined threshold, when the same word is a stop word, the probability value outputted from the smooth function is a first value greater than zero and less than one, and when the same word is not a stop word, then the probability value outputted from the smooth function is zero;
in a case where the absolute value of the distance between the same word and the answer label is greater than or equal to the predetermined threshold, the probability value outputted from the smooth function is zero; and
in a case where the distance between the same word and the answer label is equal to zero, the smooth function outputs a maximum value greater than 0.9 and less than 1.

8. The apparatus in accordance with claim 7, wherein, the first value is negatively correlated with the absolute value of the distance between the same word and the answer label.

9. The apparatus in accordance with claim 7, wherein,
the answer label is inclusive of an answer starting label and an answer ending label;
the distance between the same word and the answer label includes a starting distance between the same word and the answer starting label and an ending distance between the same word and the answer ending label;
in a case where the answer label is the answer starting label, the probability value corresponding to the same word indicates a probability of the same word being the answer starting label; and
in a case where the answer label is the answer ending label, the probability value corresponding to the same word is indicative of a probability of the same word being the answer ending label.

10. The apparatus in accordance with claim 7, wherein, the model training part is configured to use the probability value corresponding to the same word to replace a label corresponding to the same word so as to train the machine reading comprehension model.

11. The apparatus in accordance with claim 7, wherein, the answer label includes an answer starting label and an answer ending label.

12. The apparatus in accordance with claim 7, further comprising:
an answer labelling part configured to adopt the trained machine reading comprehension model to carry out answer label prediction with respect to an article and question inputted.

13. An apparatus for training a machine reading comprehension model, comprising:
a processor; and
a storage storing computer-executable instructions, connected to the processor,
wherein, the computer-executable instructions, when executed by the processor, cause the processor to perform
calculating, based on a position of each word within a training text and a position of an answer label within the training text, a distance between the same word and the answer label;
inputting the distance between the same word and the answer label into a smooth function to obtain a probability value corresponding to the same word, outputted from the smooth function; and
making the probability value corresponding to the same word serve as a smoothed label of the same word so as to train the machine reading comprehension model,
wherein,
in a case where an absolute value of the distance between the same word and the answer label is greater than zero and less than a predetermined threshold, when the same word is a stop word, the probability value outputted from the smooth function is a first value greater than zero and less than one, and when the same word is not a stop word, the probability value outputted from the smooth function is zero;
in a case where the absolute value of the distance between the same word and the answer label is greater than or equal to the predetermined threshold, the probability value outputted from the smooth function is zero; and
in a case where the distance between the same word and the answer label is equal to zero, the smooth function outputs a maximum value greater than 0.9 and less than 1.

14. The apparatus in accordance with claim 13, wherein, the first value is negatively correlated with the absolute value of the distance between the same word and the answer label.

15. The apparatus in accordance with claim 13, wherein,
the answer label is inclusive of an answer starting label and an answer ending label;
the distance between the same word and the answer label includes a starting distance between the same word and the answer starting label and an ending distance between the same word and the answer ending label;
in a case where the answer label is the answer starting label, the probability value corresponding to the same word indicates a probability of the same word being the answer starting label; and
in a case where the answer label is the answer ending label, the probability value corresponding to the same word is indicative of a probability of the same word being the answer ending label.

16. The apparatus in accordance with claim 13, wherein,
the making the probability value corresponding to the same word serve as a smoothed label of the same word so as to train the machine reading comprehension model includes
using the probability value corresponding to the same word to replace a label corresponding to the same word so as to train the machine reading comprehension model.

17. The apparatus in accordance with claim 13, wherein, the answer label includes an answer starting label and an answer ending label.

18. The apparatus in accordance with claim 13, wherein, the computer-executable instructions, when executed by the processor, cause the processor to further perform
adopting the trained machine reading comprehension model to carry out answer label prediction with respect to an article and question inputted.

19. A non-transitory computer-readable medium having computer-executable instructions for execution by a processor, wherein, the computer-executable instructions, when executed by the processor, cause the processor to conduct the method of training the machine reading comprehension model in accordance with claim 1.
